(19) United States
(12) Patent Application Publication
(10) Pub. No.: US 2014/0170038 A1
(43) Pub. Date: Jun. 19, 2014

(54) FUEL REFORMER WITH THERMAL MANAGEMENT

(71) Applicant: DELPHI TECHNOLOGIES, INC., Troy, MI (US)

(72) Inventors: BERNHARD A. FISCHER, HONEOYE FALLS, NY (US); BRUCE E. KIRCHNER, WEBSTER, NY (US); PAUL A. WILLIAMS, ROCHESTER, NY (US); DAVID R. SCHUMANN, SPENCERPORT, NY (US); DUANE E. JONES, ROCHESTER, NY (US)

(73) Assignee: DELPHI TECHNOLOGIES, INC., TROY, MI (US)

(21) Appl. No.: 13/713,039

(22) Filed: Dec. 13, 2012

(51) Int. Cl. B01J 19/00; B01J 7/00; B01J 8/00

(52) U.S. Cl. CPC B01J 19/002; B01J 8/008; B01J 7/00
USPC 422/630; 422/129; 422/240

(57) ABSTRACT

A fuel reformer includes a feedstream delivery unit and a catalytic reactor. The feedstream delivery unit is configured to receive reactants and to provide the reactants to the catalytic reactor. The reformer further includes a flame arrestor disposed between the feedstream delivery unit and the catalytic reactor, and at least one spacer disposed between the feedstream delivery unit and the catalytic reactor, wherein the spacer is configured to allow the reactants to flow therethrough while inhibiting thermal radiation therethrough. In a further aspect, the surfaces of the feedstream delivery unit that come into contact with the reactants in use include coatings that eliminate catalytic reactions of the feedstream within the feedstream delivery unit.

This invention was made with government support under contract DE-EE0000478 awarded by the Department of Energy. The government has certain rights in the invention.

### BACKGROUND OF THE INVENTION

The invention relates to a reformer assembly for generating hydrogen-containing reformate from hydrocarbons. In such an assembly, a feedstream comprising air and hydrocarbon fuel is converted by a catalyst into a hydrogen-rich reformate stream. In a typical reforming process, the hydrocarbon fuel is percolated with oxygen through a catalyst bed or beds contained within one or more reactor tubes mounted in a reformer vessel. The catalytic conversion process is typically carried out at elevated catalyst temperatures in the range of about 700° C. to 1100° C. It may be necessary to provide heat to the catalyst to achieve and maintain the required catalyst temperature.

Because the feedstream includes a volatile mixture of fuel and oxygen, it may be prone to unwanted chemical reactions before reaching the catalyst in the reactor. It is desirable in the art to provide a reformer assembly that inhibits premature chemical reactions of the feedstream.

### BRIEF SUMMARY OF THE INVENTION

A reformer assembly may experience unwanted chemical reactions of the feedstream before the feedstream reaches the catalyst. For example, hot surfaces in the reformer may promote precombustion by nature of their elevated temperatures. Structural materials in the reformer may have surfaces that exhibit catalytic properties at operating temperatures of the reformer, further promoting undesirable chemical reactions of the feedstream. Long residence time and/or poor mixing of reactants in the feedstream may trigger unwanted chemical reactions. Such chemical reactions may result in damage to the reformer. It is desirable to prevent chemical reactions of the feedstream from occurring before the feedstream reaches the catalyst.

In accordance with an aspect of the invention, a fuel reformer includes a feedstream delivery unit and a catalytic reactor. The feedstream delivery unit is configured to receive reactants and to provide the reactants to the catalytic reactor. The reformer further includes a flame arrestor disposed between the feedstream delivery unit and the catalytic reactor, and at least one spacer disposed between the feedstream delivery unit and the catalytic reactor, wherein the spacer is configured to allow the reactants to flow therethrough while inhibiting thermal radiation therethrough.

In a further aspect of the invention, the surfaces of the feedstream delivery unit that come into contact with the feedstream include coatings that eliminate catalytic reactions of the feedstream within the feedstream delivery unit.

### BRIEF DESCRIPTION OF THE DRAWINGS

The present invention will now be described, by way of example, with reference to the accompanying drawings, in which:

FIG. 1 is a schematic longitudinal cross-sectional view of a catalytic hydrocarbon reformer assembly that incorporates aspects of the invention;

FIG. 2 is a view of components in the reformer assembly of FIG. 1;

### DETAILED DESCRIPTION OF THE INVENTION

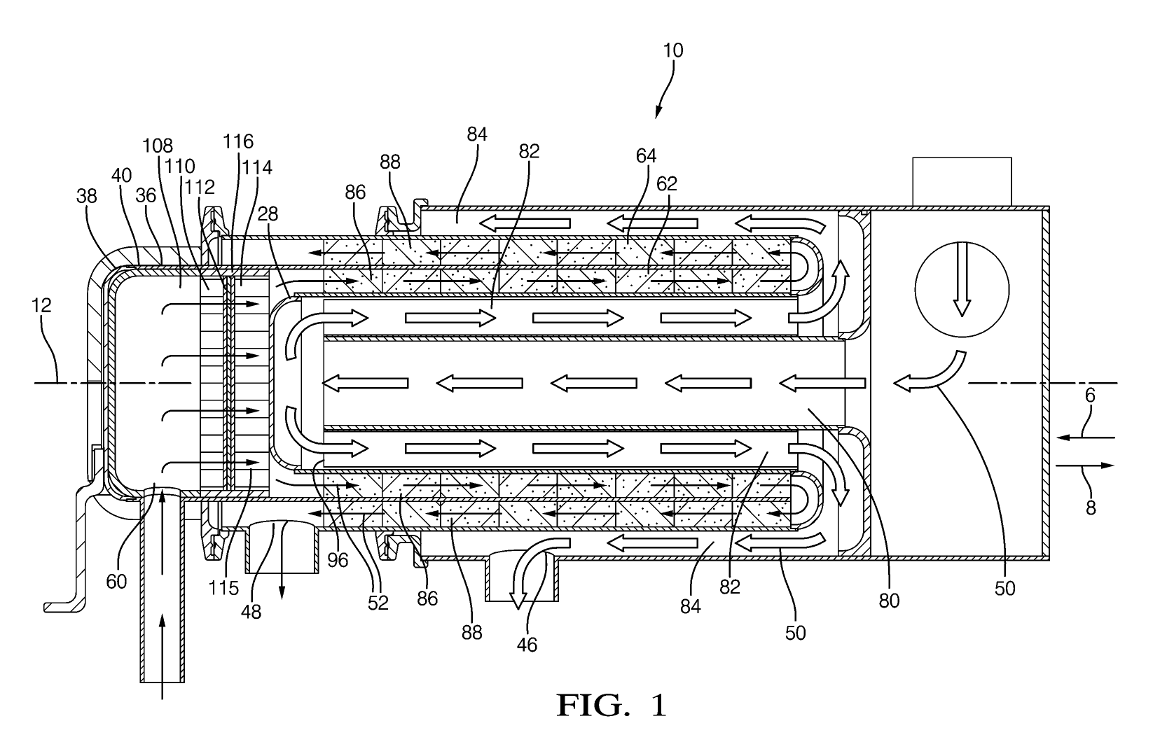

In a catalytic reformer, a feedstream containing fuel and oxygen is passed over a catalyst, thereby promoting chemical reactions producing hydrogen gas as well as other constituents. An exemplary reformer assembly that incorporates aspects of the invention is depicted in FIG. 1. A similar reformer assembly is described in commonly owned U.S. patent application Ser. No. 13/363,760, the disclosure of which is incorporated by reference in its entirety.

Referring to FIG. 1, a catalytic reformer assembly 10 having a longitudinal axis 12 comprises walls that define two separate and distinct flow paths. A first flow path 50 is indicated by open arrows for a first medium, and a second flow path 52 indicated by solid arrows for a second medium. The first medium may be a hot fluid stream used to maintain a desired temperature, and the second medium may be a feedstream comprising fuel and oxygen that is to be heated by heat transfer from the first medium. The first medium flow path 50 includes a central flow channel 80 configured to direct flow in a first axial direction 6. The first medium flow path 50 further includes a first annular flow channel 82 radially surrounding at least a portion of the central flow channel 80 and configured to direct flow from the exit of the central flow channel 80 (at endcap 28) in a second axial direction 8 opposite the first axial direction 6. The first medium flow path 50 further includes a second annular flow channel 84 radially surrounding at least a portion of the first annular flow channel 82 and configured to direct flow from the exit of the first annular flow channel 82 in the first axial direction 6. The first medium is discharged from the reformer assembly through outlet port 46.

Still referring to FIG. 1, the second medium flow path 52 comprises a third annular flow channel 86 and a fourth annular flow channel 88 each disposed radially between the first annular flow channel 82 and the second annular flow channel 84, with the third annular flow channel 86 configured to direct flow in the second axial direction 8 and the fourth annular flow channel 88 configured to direct flow in the first axial direction 6. The second medium is discharged from the reformer assembly 10 through outlet port 48.

As shown in FIG. 1, the second medium flow path may include an inner catalyst 62 disposed within the third annular flow channel 86 and/or an outer catalyst 64 disposed within the fourth annular flow channel 88. The first medium flow path 50 is fluidly isolated from the second medium flow path 52 within the catalytic reformer assembly 10, but the arrangement of the flow channels in FIG. 1 allows the first medium flow path 50 to be thermally coupled to the second medium flow path 52 so as to influence the temperature at the catalyst 62, 64.

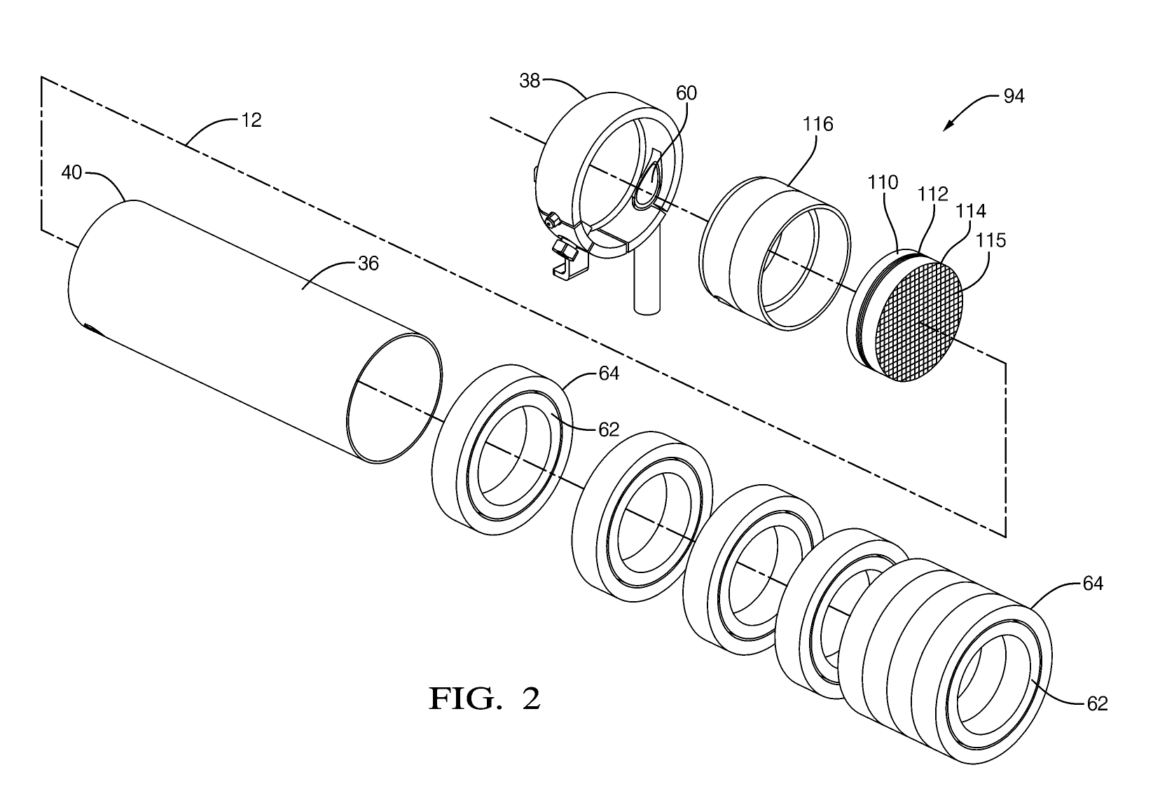

For convenience of fabrication, the reformer assembly 10 may comprise subassemblies including a combustor assembly, a reactor assembly, and a feedstream delivery unit (FDU) assembly, as described in U.S. patent application Ser. No. 13/363,760. FIG. 2 depicts portions of an FDU assembly that incorporate aspects of the invention.

Referring to FIG. 1 and FIG. 2, the feedstream delivery unit (FDU) assembly 94 comprises a tubular FDU wall 36 and an FDU endcap portion 38 that fluid tightly closes off a first end 40 of the FDU wall 36, the FDU wall 36 and the FDU endcap portion 38 defining an FDU inlet chamber 108. An FDU inlet port 60 is defined by an opening in the FDU endcap portion 38 or in the FDU wall 36. FDU assembly 94 is shown bearing a plurality of inner catalyst portions 62 disposed within the FDU wall 36 and a plurality of outer catalyst portions 64 disposed along the exterior of FDU wall 36. Each inner catalyst portion 62 and outer catalyst portion 64 comprises a substrate having a catalyst disposed on its surface, the substrate having sufficient porosity to allow fluid flow therethrough. The FDU wall 36 and the FDU endcap portion 38 are each preferably made of metal. It will be appreciated that features depicted as discrete elements of the FDU, such as the FDU wall 36 and the FDU endcap portion 38, may be further integrated with each other, or alternatively may be further divided into other combinations of components, without departing from the scope of the invention.

Continuing to refer to FIG. 1 and FIG. 2, the exemplary reformer assembly 10 also includes a flame arrestor 110, at least one radiation shield 112, and a POx catalyst substrate 114, the functions of which will be described further below. In the exemplary embodiment of FIG. 1 and FIG. 2, a wrap 116 is used to locate and secure the flame arrestor 110, the radiation shield 112, and the POx catalyst substrate 114 within the tubular FDU wall 36.

The POx catalyst substrate 114 supports a POx catalyst 115 that is used to promote a catalytic partial oxidation (POx) reaction of the feedstream to produce hydrogen gas for use in a solid oxide fuel cell. As used herein, the term POx catalyst is defined as a catalyst formulated so as to promote a reaction between a hydrocarbon fuel and oxygen at the POx catalyst 115, where the reaction is of the form:

CₙHₘ+(n/2)O₂→nCO+(m/2)H₂

The hydrogen gas produced in this partial oxidation reaction is desirable for use in a fuel cell, while the carbon monoxide may be further reacted with water within a fuel reformer to produce additional hydrogen in a reaction of the form:

CO+H₂O→CO₂+H₂

The partial oxidation reaction at the POx catalyst 115 is exothermic, resulting in elevated temperature at the POx catalyst 115 and/or at the POx catalyst substrate 114. Exposure to the hot surface of the POx catalyst 115 can promote premature combustion of the feedstream in the FDU.

In an advantageous embodiment the flame arrestor 110 comprises a plurality of channels each having a length in the axial direction that is greater than a width in a direction perpendicular to the axial direction. The dimensions and aspect ratio of the channels defined in the flame arrestor are chosen to allow flow of the feedstream through the reactor (in the direction of the arrows 52) while maintaining velocities in the channels sufficient to inhibit propagation of a flame front in a direction opposite the direction of the arrows 52 into the FDU inlet chamber 108.

Similarly, in an advantageous embodiment the POx catalyst substrate 114 comprises a plurality of channels each having a length in the axial direction that is greater than a width in a direction perpendicular to the axial direction. The dimensions and aspect ratio of the channels defined in the POx catalyst substrate 114 are chosen to allow flow of the feedstream through the reactor (in the direction of the arrows 52) while maintaining velocities in the channels sufficient to inhibit propagation of a flame front in a direction opposite the direction of the arrows 52 into the FDU inlet chamber 108.

In addition to the flame arrestor 110, the exemplary reformer 10 also includes one or more spacers 112 located between the inlet port 60 of the FDU and the POx catalyst substrate 114. The spacers 112 preferably comprise ceramic paper or ceramic cloth. As used herein, ceramic paper is understood to mean a sheet material comprising ceramic fibers oriented randomly, and ceramic cloth is understood to mean a sheet material comprising ceramic fibers arranged in a woven orientation. The spacers 112 are porous enough to allow flow of the feedstream therethrough while inhibiting thermal radiation from the POx catalyst substrate 114 and/or the POx catalyst 115 from reaching the FDU inlet chamber 108.

The inventors have recognized that at elevated temperatures that may be found in the inlet chamber 108, the materials used in the construction of the FDU assembly 94 may contribute to fostering unwanted chemical reactions in the FDU assembly 94. Metal alloys may assume catalytic tendencies or promote deposition of carbon which can act as a hot spot to initiate premature combustion of the fuel/oxygen mixture. Several alternatives are available to be used, either alone or in combination, to mitigate the promotion of undesirable chemical reactions in the FDU. In one aspect of the invention, metallic structural components in the FDU comprise Alloy 625, an industry standard nickel-chromium based alloy. In another aspect of the invention, metallic structural components in the FDU comprise aluminized stainless steel. In another aspect of the invention, structural components in the FDU are coated with a coating material, for example yttria-stabilized zirconia, to create a thermal barrier.

While the invention has been described in terms of specific embodiments, the present invention can be further modified within the spirit and scope of this disclosure. This application is intended to cover any variations, uses, or adaptations of the present invention using the general principles disclosed herein. Further, this application is intended to cover such departures from the present disclosure as come within the known or customary practice in the art to which this invention pertains and which fall within the limits of the claims which follow.

We claim:

1. A fuel reformer comprising a feedstream delivery unit and a catalytic reactor, the feedstream delivery unit configured to receive reactants through an inlet port and to provide the reactants to the catalytic reactor, said reformer further comprising:
a flame arrestor disposed between the inlet port of the feedstream delivery unit and the catalytic reactor;
at least one spacer disposed between the inlet port of the feedstream delivery unit and the catalytic reactor, said spacer configured to allow the reactants to flow therethrough while inhibiting thermal radiation therethrough.

2. The fuel reformer of claim 1, wherein the flame arrestor defines a plurality of channels therethrough, wherein the channels are configured such that the velocity of reactants flowing therethrough from the inlet port of the feedstream delivery unit to the catalytic reactor is sufficient to inhibit propagation of combustion from the catalytic reactor to the feedstream delivery unit.

3. The fuel reformer of claim 1, wherein the spacer comprises a ceramic material.

4. The fuel reformer of claim 3, wherein the spacer comprises ceramic paper or ceramic cloth.

5. The fuel reformer of claim 1 further comprising a substrate disposed between the inlet port of the feedstream delivery unit and the catalytic reactor, said substrate having a surface that is at least partially coated with a partial oxidation catalyst.

6. The fuel reformer of claim 5 wherein the substrate defines a plurality of channels therethrough, wherein the channels are defined by channel walls, and wherein the channels are configured such that the velocity of reactants flowing therethrough from the inlet port of the feedstream delivery unit to the catalytic reactor is sufficient to inhibit propagation of combustion from the catalytic reactor to the feedstream delivery unit.

7. The fuel reformer of claim 6 wherein the partial oxidation catalyst is disposed on at least one wall of at least one channel.

8. The fuel reformer of claim 1 wherein a surface of the feedstream delivery unit that is exposed to the reactants comprises Alloy 625.

9. The fuel reformer of claim 1 wherein a surface of the feedstream delivery unit that is exposed to the reactants comprises aluminized stainless steel.

10. The fuel reformer of claim 1 wherein a surface of the feedstream delivery unit is coated with yttria-stabilized zirconia.
